(19) United States
(12) Patent Application Publication
(10) Pub. No.: US 2021/0324502 A1
(43) Pub. Date: Oct. 21, 2021

(54) MAGNESIUM ALLOY, IN PARTICULAR FOR LASER DEPOSITION WELDING

(71) Applicant: HELMHOLTZ-ZENTRUM GEESTHACHT ZENTRUM FUER MATERIAL-UND KUESTENFORSCHUNG, Greesthacht (DE)

(72) Inventors: Hajo DIERINGA, Lueneburg (DE); Jan BOHLEN, Lueneburg (DE)

(21) Appl. No.: 17/232,299

(22) Filed: Apr. 16, 2021

(30) Foreign Application Priority Data
Apr. 16, 2020 (EP) 20 169 834.7

(51) Int. Cl. C22C 23/02; B23K 35/02; B23K 35/28; B23K 26/21

(52) U.S. Cl. CPC C22C 23/02; B23K 35/0216; B23K 2103/15; B23K 26/21; B23K 35/284

(57) ABSTRACT

A magnesium alloy is set forth, preferably for producing an, in particular wire-shaped or band-shaped, welding consumable for, in particular wire-based, laser deposition welding. The magnesium alloy consists of the following constituent substances with regard to the total weight of the alloy:
3.0% by weight to 9.0% by weight of aluminum (Al),
0.2% by weight to 2.0% by weight of calcium (Ca),
0.1% by weight to 0.8% by weight of manganese (Mn),
0.2% by weight to 2.0% by weight of aluminum nitride (AlN),
   and magnesium and unavoidable, in particular production-related, contaminants as the rest.

This description relates to a magnesium alloy and to a use of a magnesium alloy. This description also relates to a welding consumable for, in particular wire-based, laser deposition welding and to a method for producing a, preferably metal, component and a component, preferably metal component.

Magnesium alloys are generally known. They are characterized by a good ratio of strength to density. Magnesium alloys can also be easily mechanically processed.

DE 11 2007 002 016 T5 discloses a high-strength, non-flammable magnesium alloy. The alloy is produced by adding at least one additional additive, selected from carbon (C), molybdenum (Mo), niobium (Nb), silicon (Si), tungsten (W), aluminum oxide (Al₂O₃), magnesium silicide (Mg₂Si), and silicon carbide (SiC), to form a non-flammable magnesium alloy, and by adding 0.5 to 5.0% calcium by mass.

Furthermore, EP 1 400 605 B1 describes a wire made of a magnesium alloy and a production process for it.

An object of this description is to set forth a magnesium alloy that is not or is hardly flammable, wherein in particular the magnesium alloy should be suitable, for example, for use in laser deposition welding and the production of components with laser deposition welding should be improved.

This object is achieved by a magnesium alloy, preferably for producing an, in particular wire-shaped or band-shaped, welding consumable for, in particular wire-based, laser deposition welding, wherein the magnesium alloy consists of the following constituent substances with regard to the total weight of the alloy:
3.0% by weight to 9.0% by weight of aluminum (Al),
0.2% by weight to 2.0% by weight of calcium (Ca),
0.1% by weight to 0.8% by weight of manganese (Mn),
0.2% by weight to 2.0% by weight of aluminum nitride (AlN),
   and magnesium and unavoidable, in particular production-related, contaminants as the rest.

The advantage of the magnesium alloy according to this description consists in that, by adding or alloying calcium (Ca) to the raw material magnesium alloy, the flammability of the alloy is greatly reduced or prevented. In addition, the additional addition of aluminum nitride (AlN), which is preferably added in the form of nanoparticles, achieves a significant grain refinement in the produced alloy. A particular advantage provided by aluminum nitride, or the aluminum nitride nanoparticles in the magnesium alloy, consists in that the grain refinement of the alloy remains, or is present, even after remelting and rehardening of the alloy.

The combination according to this description of the constituent substances of the magnesium alloy or the alloying of the constituent substances causes the flammability of the magnesium alloy according to this description to be reduced and grain refinement to also be formed. Due to these properties of the magnesium alloy, it is particularly suitable for application or use as a welding material or as a laser welding wire for laser deposition welding, since the magnesium alloy does not ignite when the magnesium alloy is fused as a welding consumable material by a high-energy laser beam of a laser deposition welding device. Furthermore, during or after applying the welding material to an, in particular metal, component, the mechanical properties of a component provided with a with the magnesium alloy on a surface are improved.

As components, metal components, for example, are provided on their surface with a structure made of the magnesium alloy by means of laser deposition welding. In one embodiment, the structures can be formed both in a planar manner and in a three-dimensional shape on the surface by fusing the magnesium alloy. In one development, the components can be, inter alia, preferably metal, components or semi-finished products from the areas of mechanical engineering, automobiles, motors, ships, and/or aircraft. Other, preferably metal, components from other areas and industries that are provided with the magnesium alloy are also possible within the scope of this description.

According to the prior art, magnesium alloys are not or are hardly used for the laser deposition welding methods, because their use presents a considerable fire hazard. This fire hazard during laser deposition welding is avoided by the alloy according to this description. The mechanical properties of the component are significantly increased by the fine grain of the welding material consisting of or produced from the magnesium alloy, which increases the application possibilities for magnesium materials for laser deposition welding.

It is preferably provided that the lower limit of the proportion of aluminum (Al) in percent by weight for the magnesium alloy is selected from the group of the following values {3.0; 3.1; 3.2; 3.3; 3.4; 3.5; 3.6; 3.7; 3.8; 3.9; 4.0; 4.1; 4.2; 4.3; 4.4; 4.5; 4.6; 4.7; 4.8; 4.9; 5.0; 5.1; 5.2; 5.3; 5.4; 5.5; 5.6; 5.7; 5.8; 5.9; 6.0; 6.1; 6.2; 6.3; 6.4; 6.5; 6.6; 6.7; 6.8; 6.9; 7.0; 7.1; 7.2; 7.3; 7.4; 7.5; 7.6; 7.7; 7.8; 7.9; 8.0; 8.1; 8.2; 8.3; 8.4; 8.5; 8.6; 8.7; 8.8; 8.9; 9.0} and the upper limit of aluminum (Al) in the proportion in percent by weight is selected from the group of the following values {3.0; 3.1; 3.2; 3.3; 3.4; 3.5; 3.6; 3.7; 3.8; 3.9; 4.0; 4.1; 4.2; 4.3; 4.4; 4.5; 4.6; 4.7; 4.8; 4.9; 5.0; 5.1; 5.2; 5.3; 5.4; 5.5; 5.6; 5.7; 5.8; 5.9; 6.0; 6.1; 6.2; 6.3; 6.4; 6.5; 6.6; 6.7; 6.8; 6.9; 7.0; 7.1; 7.2; 7.3; 7.4; 7.5; 7.6; 7.7; 7.8; 7.9; 8.0; 8.1; 8.2; 8.3; 8.4; 8.5; 8.6; 8.7; 8.8; 8.9; 9.0}, wherein the lower limit of the proportion of aluminum (Al) is less than the upper limit of the proportion or the lower limit of the proportion is the same as the upper limit of the proportion.

It is preferably provided that the lower limit of the proportion of calcium (Ca) in percent by weight for the magnesium alloy is selected from the group of the following values {0.2; 0.3; 0.4; 0.5; 0.6; 0.7; 0.8; 0.9; 1.0; 1.1; 1.2; 1.3; 1.4; 1.5; 1.6; 1.7; 1.8; 1.9; 2.0} and the upper limit of calcium (Ca) of the proportion in percent by weight is selected from the group of the following values {0.2; 0.3; 0.4; 0.5; 0.6; 0.7; 0.8; 0.9; 1.0; 1.1; 1.2; 1.3; 1.4; 1.5; 1.6; 1.7; 1.8; 1.9; 2.0}, wherein the lower limit of the proportion of calcium (Ca) does not exceed the upper limit of the proportion or the lower limit of the proportion is the same as the upper limit of the proportion.

It is preferably provided that the lower limit of the proportion of manganese (Mn) in percent by weight for the magnesium alloy is selected from the group of the following values {0.1; 0.2; 0.3; 0.4; 0.5; 0.6; 0.7; 0.8} and the upper limit of manganese (Mn) of the proportion in percent by weight is selected from the group of the following values {0.1; 0.2; 0.3; 0.4; 0.5; 0.6; 0.7; 0.8}, wherein the lower limit of the proportion of manganese (Mn) is less than the upper limit of the proportion or the lower limit of the proportion is the same as the upper limit of the proportion.

It is preferably provided that the lower limit of the proportion of aluminum nitride (AlN) in percent by weight for the magnesium alloy is selected from the group of the following values {0.2; 0.3; 0.4; 0.5; 0.6; 0.7; 0.8; 0.9; 1.0; 1.1; 1.2; 1.3; 1.4; 1.5; 1.6; 1.7; 1.8; 1.9; 2.0} and the upper limit of aluminum nitride (AlN) of the proportion in percent by weight is selected from the group of the following values {0.2; 0.3; 0.4; 0.5; 0.6; 0.7; 0.8; 0.9; 1.0; 1.1; 1.2; 1.3; 1.4; 1.5; 1.6; 1.7; 1.8; 1.9; 2.0}, wherein the lower limit of the proportion of aluminum nitride (AlN) is less than the upper limit of the proportion or the lower limit of the proportion is the same as the upper limit of the proportion.

According to a development of the magnesium alloy, it is provided that aluminum nitride is present as nanoparticles, in particular with a particle size of 80 nm (nanometers) to 400 nm (nanometers), preferably from 80 nm to 250 nm, in, preferably maximum, diameter.

Furthermore, the object is achieved by a welding consumable for, in particular wire-based, laser deposition welding, wherein the welding consumable is produced from a magnesium alloy described above. For more details, reference is made to the embodiments above in order to prevent repetitions. During laser deposition welding, the welding consumable, which is designed, for example, as a laser welding wire, is fused in the area of an, in particular metal, surface of a component by means of the high-energy radiation of a laser, wherein the surface of the component is also locally fused simultaneously, as a result of which the fused welding material consisting of the magnesium alloy binds with the metal surface of the component at the fused point, as a result of which the magnesium alloy is applied to the surface of the component.

For this purpose, in one embodiment, for the welding consumable it is provided for the welding consumable to be designed as a wire, in particular with a diameter of 0.5 mm (millimeters) to 2.0 mm (millimeters), or as a band, in particular with a diameter of 0.5 mm to 2.0 mm.

According to one aspect, the welding consumable is also characterized in that the welding consumable is produced according to an extrusion process. Within the scope of this description, it is possible for the welding consumable to be extruded using an extrusion device, wherein the extrusion device is operated according to a direct or indirect or hydrostatic extrusion method.

In the case of direct extrusion, it is provided, for example, for a punch to press a block consisting of a magnesium alloy along an inner surface of a recipient in the direction of a die. Indirect extrusion is characterized in that the recipient is closed on one side, wherein the die, which is located on the head of a hollow punch, is pressed onto the block consisting of the magnesium alloy from the other side of the recipient. During pressing, the strand is pressed through a punch hole. The hydrostatic extrusion method is implemented in that the pressing force from the punch is not applied directly; instead, it is applied via an active medium (oil).

Another achievement of the object is effected by a use of a magnesium alloy described above to produce an, in particular wire-shaped or band-shaped, welding consumable for, in particular wire-based, laser deposition welding.

In this case, in one development, for the welding consumable it is provided that the welding consumable is designed as a wire, in particular with a diameter of 0.5 mm to 2.0 mm, or as a band, in particular with a diameter of 0.5 mm to 2.0 mm.

In particular, the welding consumable can be produced or is produced according to an extrusion method.

One embodiment of the use of the magnesium alloy is characterized in that the magnesium alloy is applied as a structure to a, preferably metal, surface of a, preferably metal, component, in particular by fusing.

The object is also achieved by a method for producing a, preferably metal, component, wherein a structure made of a magnesium alloy, as described above, is applied to a, preferably metal, surface of the component by means of, preferably wire-based, laser deposition welding using a laser deposition welding device, in particular by fusing.

For this purpose, it is provided in particular for a welding consumable produced from the magnesium alloy to be applied to the surface of the component by means of the laser deposition welding device. In this case, the welding consumable is fused by means of a laser of the laser deposition welding device and applied to the component.

Preferably, the welding consumable is designed as a wire or band.

Moreover, the object is achieved by a component, preferably metal component, with a, preferably metal, surface, wherein a structure made of a magnesium alloy described above is applied to the surface of a component, in particular by a laser deposition welding method.

According to an advantageous embodiment, it is provided in the case of the component for the structure to be applied to the surface of the component by means of an, in particular wire-based, laser deposition welding method by fusing a welding consumable described above.

1. A magnesium alloy for producing a wire-shaped or band-shaped, welding consumable for wire-based, laser deposition welding, wherein the magnesium alloy consists of the following constituent substances with regard to the total weight of the alloy:
3.0% by weight to 9.0% by weight of aluminum (Al),
0.2% by weight to 2.0% by weight of calcium (Ca),
0.1% by weight to 0.8% by weight of manganese (Mn),
0.2% by weight to 2.0% by weight of aluminum nitride (AlN),
and magnesium and unavoidable production-related, contaminants as the rest.

2. The magnesium alloy according to claim 1, characterized in that aluminum nitride is present as nanoparticles with a particle size of 80 nm to 400 nm, preferably from 80 nm to 250 nm, in, maximum diameter.

3. A welding consumable for wire-based, laser deposition welding, wherein the welding consumable is produced from a magnesium alloy according to claim 1.

4. The welding consumable according to claim 3, characterized in that the welding consumable is designed as a wire with a diameter of 0.5 mm to 2.0 mm, or as a band with a diameter of

0. 5 mm to 2.0 mm.

5. The welding consumable according to claim 3, characterized in that the welding consumable is produced according to an extrusion method.

6. A use of a magnesium alloy according to claim 1 for producing a wire-shaped or band-shaped welding consumable for wire-based, laser deposition welding.

7. The use according to claim 6, characterized in that the welding consumable is designed as a wire with a diameter of 0.5 mm to 2.0 mm, or as a band with a diameter of 0.5 mm to 2.0 mm.

8. The use according to claim 6, characterized in that the welding consumable is produced according to an extrusion method.

9. The use according to claim 6, characterized in that the magnesium alloy is applied as a structure to a metal surface of a metal component by fusing.

10. A method for producing a metal component, wherein a structure made of a magnesium alloy according to claim 1 is applied to a metal surface of the component by means of wire-based, laser deposition welding using a laser deposition welding device by fusing.

11. The method according to claim 10, characterized in that a welding consumable produced from the magnesium alloy is applied to the surface of the component by means of the laser deposition welding device.

12. The method according to claim 10, characterized in that the welding consumable is designed as a wire or band.

13. A metal component with a metal, surface, wherein a structure made of a magnesium alloy according to claim 1 is applied to the surface of the component.

14. The component according to claim 13, characterized in that the structure is applied to the surface of the component by means of a wire-based, laser deposition welding method by fusing a welding consumable.

15. A welding consumable for wire-based, laser deposition welding, wherein the welding consumable is produced from a magnesium alloy according to claim 2.

16. The welding consumable according to claim 15, characterized in that the welding consumable is designed as a wire with a diameter of 0.5 mm to 2.0 mm, or as a band with a diameter of 0.5 mm to 2.0 mm.

17. A use of a magnesium alloy according to claim 2 for producing a wire-shaped or band-shaped, welding consumable for wire-based, laser deposition welding.

18. A method for producing a metal component, wherein a structure made of a magnesium alloy according to claim 2 is applied to a metal surface of the component by means of wire-based, laser deposition welding using a laser deposition welding device by fusing.

19. A metal component with a metal, surface, wherein a structure made of a magnesium alloy according to claim 2 is applied to the surface of the component.
